(19) United States
(12) Patent Application Publication
(10) Pub. No.: US 2013/0321761 A1
(43) Pub. Date: Dec. 5, 2013

(54) METHODS AND DEVICE FOR ATTACHING EYEGLASSES TO READING MATERIALS

(71) Applicant: Alice W. JOSEPH, Chevy Chase, MD (US)

(72) Inventor: Alice W. JOSEPH, Chevy Chase, MD (US)

(21) Appl. No.: 13/891,002

(22) Filed: May 9, 2013

Related U.S. Application Data
(60) Provisional application No. 61/645,966, filed on May 11, 2012.

(51) Int. Cl. G02C 3/00; A45C 11/06

(52) U.S. Cl. CPC G02C 3/00; A45C 11/06
USPC 351/158; 29/428

(57) ABSTRACT

Methods and associated devices are provided that provide a mechanism to attach eyeglasses to reading materials, such as books, electronic tablets, and magazines, among other types of reading materials, and for the devices to also be usable as a bookmark In addition, methods and associated devices also provide a mechanism to attach eyeglasses to various locations, such as a car visor.

The current application claims priority from U.S. provisional patent application No. 61/645,966, filed on May 11, 2012, titled “Methods and Apparatus for Attaching Eyeglasses to Reading Materials,” and which is incorporated herein by reference in its entirety.

### BACKGROUND OF THE INVENTION

1. Field of the Invention

Aspects of the present invention relate to a device for holding eyeglasses and methods for constructing the same. More particularly, aspects of the present invention relate to devices and methods for attaching eyeglasses to reading materials.

2. Background of the Related Art

When an individual requires eyeglasses to read selected reading materials, the eyeglasses can easily be misplaced and/or placed in a different location than the current location of the individual. As a result, the individual may spend a considerable amount of time trying to locate their eyeglasses before being able to read the selected reading materials.

Thus, it would be desirable to have a device that allows an individual to attach eyeglasses to the reading material so that the individual does not have to waste time and effort attempting to locate eyeglasses prior to reading.

### SUMMARY

In view of the above problems and shortcomings, aspects of the present invention include methods and associated devices that, among other things, provide a mechanism to attach eyeglasses to reading materials, such as books, electronic tablets, and magazines, among other types of reading materials. In addition, aspects of the present invention include methods and associated devices that provide a mechanism to attach eyeglasses to locations, such as a car visor, where individuals may need a set of eyeglasses to read or to shade their eyes from the sun.

Additional advantages and novel features relating to aspects of the present invention will be set forth in part in the description that follows, and in part will become more apparent to those skilled in the art upon examination of the following or upon learning by practice thereof.

### DESCRIPTION OF THE FIGURES

Various example aspects of the systems and methods will be described in detail, with reference to the following figures, wherein:

FIGS. 1A and 1B illustrate an example device for securing eyeglasses to a reading material in accordance with various aspects of the present invention;

FIG. 2 illustrates an example method flow for constructing an eyeglass securing device in accordance with various aspects of the present invention;

FIGS. 3A-3B illustrate an example device for securing eyeglasses, according to various aspects of the current invention;

FIGS. 4A-4D illustrates views of the portions of an example eyeglass securing device prior to assembly in accordance with various aspects of the present invention; and

FIGS. 5A-5D illustrate a method of assembling the device for attaching eyeglasses to reading materials, according to various aspects of the current invention.

### DETAILED DESCRIPTION

These and other features and advantages in accordance with aspects of this invention are described in, or are apparent from, the following detailed description of various example aspects.

Aspects of the present invention relate to a device for securing eyeglasses to reading material, such as a book, an electronic tablet (e.g., Kindle™ or iPad™), or a magazine, among other reading materials. In addition, aspects of the present invention include methods and associated devices that provide mechanisms to attach eyeglasses to various locations, such as a car visor, where individuals may need a set of eyeglasses, such as to read a map and/or block the sun.

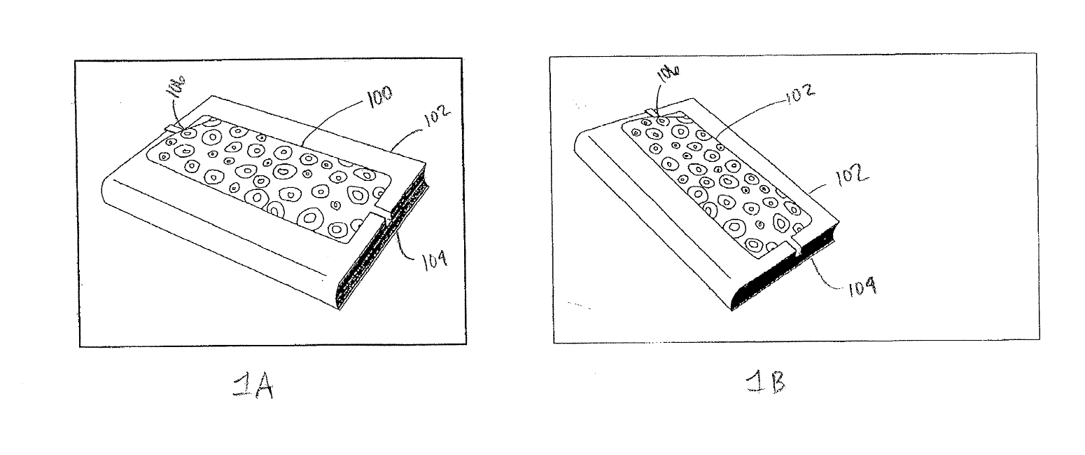

FIGS. 1A and 1B illustrate an example device for securing eyeglasses to a reading material in accordance with various aspects of the present invention. In FIGS. 1A and 1B, therein illustrated is an example eyeglass securing device 100, such as an eyeglass case, in accordance with an aspect of the present invention. The eyeglass case 100 may include an attaching component 104 operable to attach the eyeglass case 100 to a reading material 102 or other item. Reading materials may include, but are not limited to, books, magazines, electronic tablets, calendars, and notebooks, among other reading materials.

In an aspect of the present invention, the attaching component 104 may also be used as a marker (e.g., a bookmark) to hold a location in the reading material. Thus, the attaching component 104 may be used to attach the eyeglass case 100 to the reading material, as well as to serve as a bookmark to mark a location within the reading material. For example, the attaching component 104 may stretch around the pages of the reading material 102 that an individual has already read and mark a location in the reading material 102 where the individual has stopped reading. According to various aspects, the attaching component 104 may comprise a stretchable material, such as, but not limited to, elastic, rubber, neoprene, or fabric, among other stretchable materials capable of stretching around a piece of reading material 102 and securing the eyeglass case 100 to the reading material 102.

In addition, the eyeglass case 100 may also include a closure 106 operable to prevent the eyeglasses from falling out of the eyeglass case 100. According to various aspects, the closure 106 may include a snap, Velcro®, a fastener, a button, or a zipper, among other closures that can prevent the eyeglasses from falling out of the eyeglass case 100.

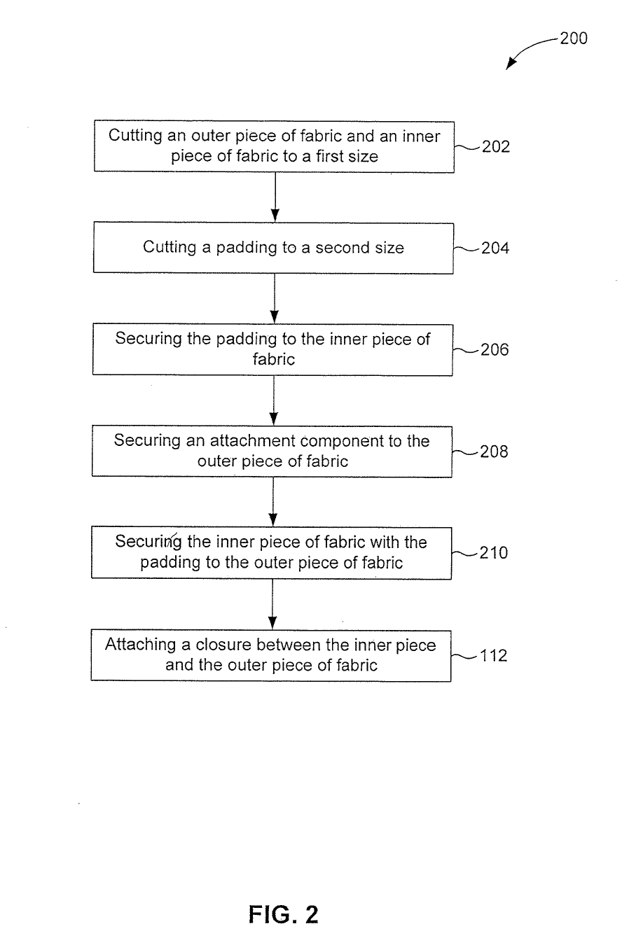

FIG. 2 illustrates an example method flow for constructing an eyeglass securing device in accordance with various aspects of the present invention. In FIG. 2, illustrated therein is a flow chart of an example method 200 for constructing an eyeglass case in accordance with an aspect of the present invention. According to various aspects, the method may include cutting an outer piece of fabric and an inner piece of fabric to a first size 202. The outer and inner pieces of fabric may include fabrics such as, but not limited to, cotton, silk, fleece, or wool, among other types of fabrics that may not scratch the eyeglasses. In addition, the outer piece of fabric may include aesthetic features, such as colors, patterns, logos, and/or other designs. In an aspect, the outer and inner pieces of fabric may be cut in a generally square shape with a curve at a top end of the fabric. By having a curve at the top end of the inner and outer pieces of fabric, a portion of the inner piece of fabric may be made visible from the outside of the eyeglass case upon assembly. The shape and size of the outer and inner pieces of fabric may be variable based upon, for example, the type and/or the size of the eyeglasses and the desired shape of the case.

According to various aspects, the method may also include cutting padding to a second size 204. The padding may include any material that may enhance protection of the eyeglasses. Examples of padding include, but are not limited to, foam, cotton, fleece, or rubber. In an aspect, the second size may be smaller than the first size to prevent the padding from being placed within the seams. In another aspect, the second size may be larger than the first size so that the padding may be sewn into the seam (e.g., the padding may be sewn just past the seam and may catch in the seam). For example, for a first size of 6.5 inches by 9.5 inches, the second size may be ⅝ of an inch smaller in a cross-sectional size than the first size.

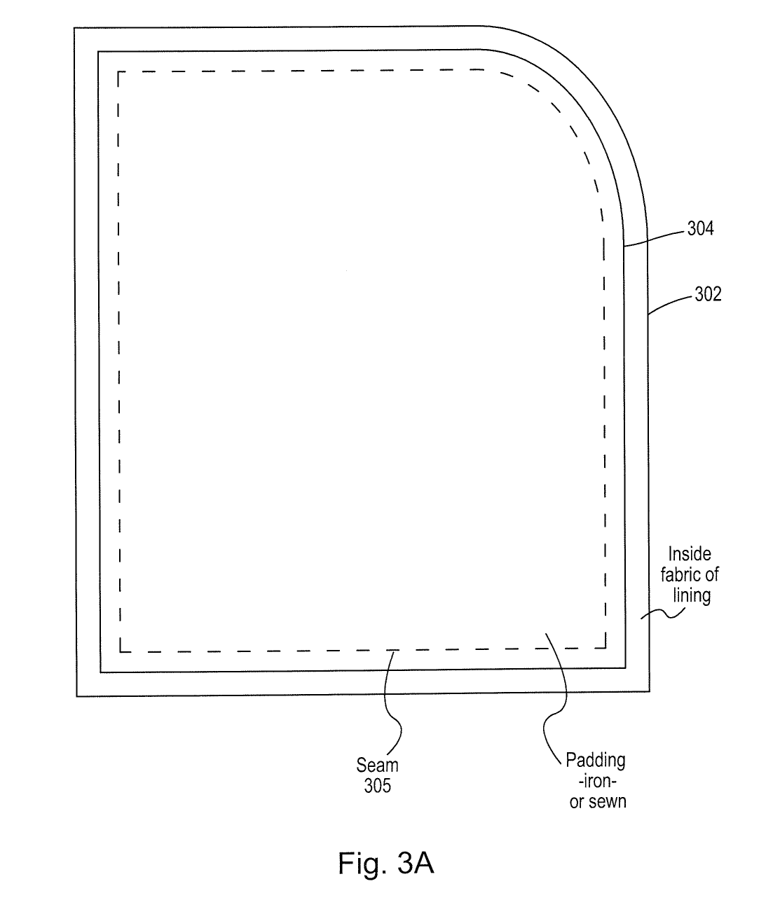

According to various aspects, the method may further include securing the padding to the inner piece of fabric 206. The padding may be secured to the inner fabric by, for example, pressing the padding to the inner fabric (e.g., ironing the padding to the inner fabric), gluing the padding to the inner fabric, sewing the padding to the inner fabric, or via any other suitable method of joining the padding to the inner fabric. An example of securing the padding 304 to the inner fabric 302 is illustrated in FIG. 3A, which also illustrates the seam 305.

According to various aspects, the method may additionally include securing an attachment component to the outer piece of fabric at 208 in FIG. 2. As discussed above, the attachment component may comprise a piece of elastic that may be used to connect the eyeglass case to a piece of reading material. Thus, the attachment component may be capable of expanding to accommodate a variety of reading materials, such as hardcover books, paperback books, electronic tablets, and magazines, among other reading materials. For example, the size of the attachment component may be based upon a number of pages of the reading material that the attachment component should stretch around, e.g., 100 pages. However, it should be noted that the size of the attachment component may be customized to fit any sized reading material. In addition, the attachment component may be capable of expanding around pages in the reading materials to be used as a marker (e.g., a bookmark) to hold a place in the reading material.

FIGS. 3A-3B illustrate various aspects of a method for constructing an eyeglass securing device. In FIG. 3B, illustrated is an example diagram of securing the attachment component 308 to the outer fabric 306. In an aspect, the attachment component 308 may be secured to the outer fabric 306 at a top seam 310a and/or a bottom seam 310b. The attachment component 308 may be secured, for example, by sewing the attachment component 308 to the top and bottom seams 310a and 310b, respectively. In addition, the attachment component 308 may be reinforced where stress may be applied when the attachment component 308 is in use, e.g., at seams 310a and 310b. It should be appreciated that sewing the attachment component 308 to the outer fabric 306 is only one example of securing the attachment component 308 to the outer fabric 306 and that a variety of methods and/or devices may be used to secure the attachment component 308 to the outer fabric 306.

Referring back to FIG. 2, the method may also include securing the inner piece of fabric with the padding to the outer piece of fabric 210. In an aspect, the inner piece of fabric, illustrated as element 302 in FIG. 3A, may be sewn or otherwise attached to the outer piece of fabric covering the attachment component. After the inner piece of fabric 302 is secured to the outer piece of fabric, the fabrics may be turned “inside out” such that the padding 304 and the inner piece of fabric 302 may face the inner portion of the eyeglass case, and the outer piece of fabric with the attachment component 308 are located on the outer portion of the eyeglass case. By turning the fabrics “inside out,” the seams 305 where the inner and outer fabrics are secured together may not be visible from outside the eyeglass case. In addition, the seams connecting the attachment component 308 to the outer fabric may also not be visible from outside the eyeglass case.

The method may optionally include attaching a closure between the inner and outer pieces of fabric 212. By attaching a closure between the inner and outer pieces of fabric, the eyeglasses stored within the eyeglass case are less likely to escape from the eyeglass case. The closure may be, but is not limited to, a snap, Velcro®, a button, or a zipper, among other closures. In an aspect, the closure may be attached near seam 310a (FIG. 3B) so that the closure is near the middle of the eyeglass case. It should be noted that the closure may be sewn and/or glued to the lining fabric and may not be visible.

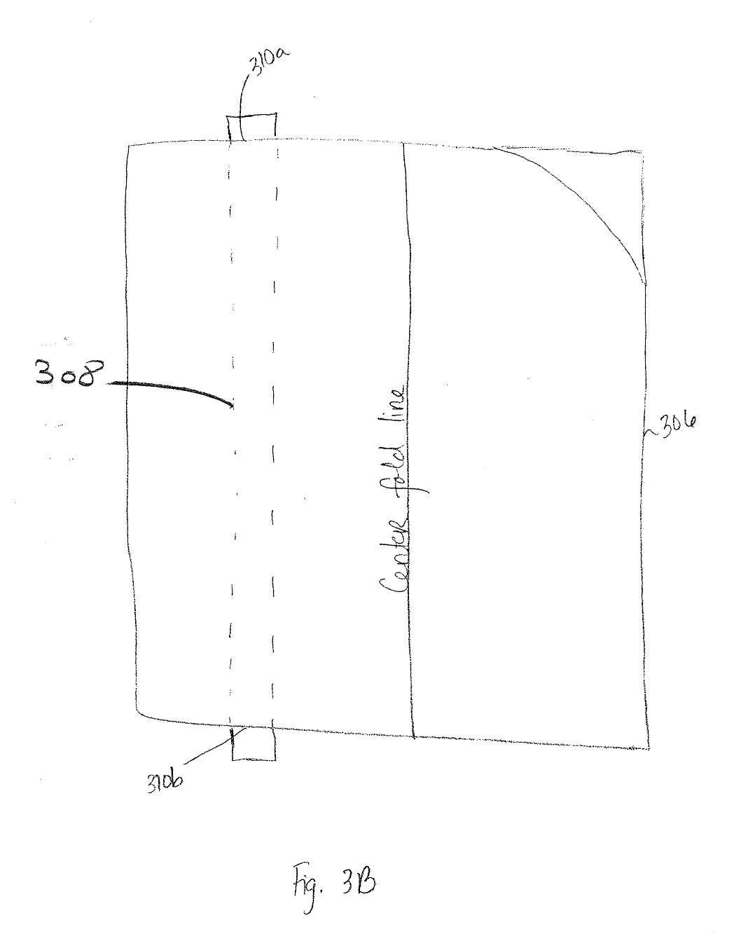

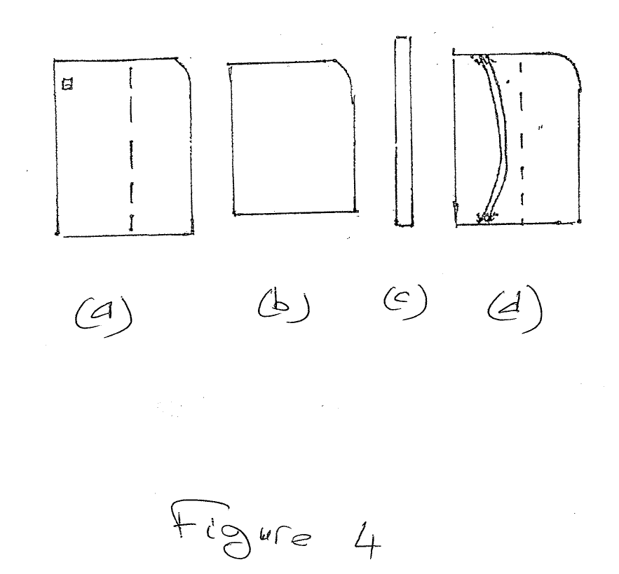

FIGS. 4A-4D illustrate views of the portions of an example eyeglass securing device prior to assembly in accordance with various aspects of the present invention. In FIGS. 4A-4D, illustrated therein are views of the portions of an example eyeglass securing device in various stages of assembly, as well as descriptive information relating thereto, in accordance with an aspect of the present invention.

FIG. 4A illustrates a template for an inner and outer fabric, according to various aspects. FIG. 4B illustrates a template for a padding, according to various aspects. FIG. 4C illustrates an example attaching component in the form of an elastic band, according to various aspects. FIG. 4D illustrates a securing device that includes the attaching component attached to a side of the fabric, according to various aspects.

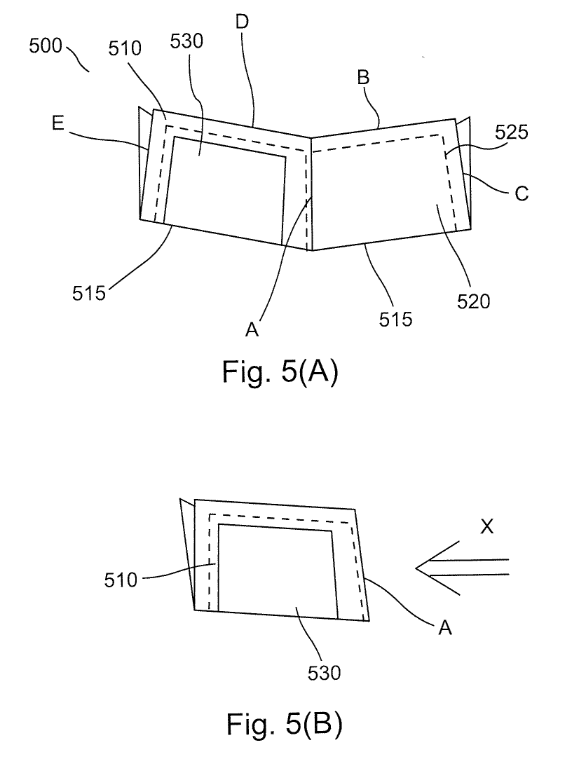

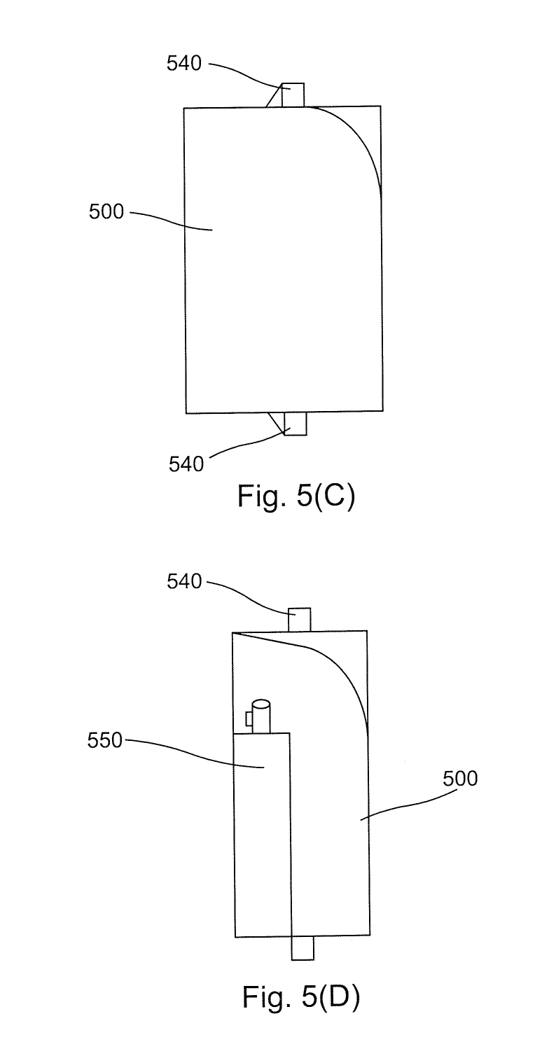

FIGS. 5A-5D illustrate a method of assembling the device 500 for attaching eyeglasses to reading materials, according to various aspects of the current invention. In FIG. 5A, the fabric 510 (the fabric comprising the outer surface of the assembled holder, also interchangeably referred to herein as the “outer fabric”) and the lining 520 (also interchangeably referred to herein as the “inner fabric”) are both folded along a fold line 515, and may be sewn together along the dotted lines 525. According to various aspects, the fabric 510 includes the padding 530 that is fixed to the fabric 510 on an inside surface of the fabric 510.

According to various aspects, the fabric 510 and the lining 520 are sewn to each other along edge A, the fabric 510 is also sewn to itself at the aligned edges on sides D and E after folding, and the lining is sewn to itself at the aligned edges on sides B and C after folding. As such, as illustrated in FIG. 5B, the lining 520, once sewn to the fabric 510 as indicated with regard to FIG. 5A, may then be inserted into the pocket or cavity formed in fabric 510 along direction X in order to create an opening to receive an object such as, for example, a pair of eyeglasses, and also to provide cushioning when a glass-based material such as eyeglasses is placed inside the cavity of the device 500. As a result, the device 500 includes a lined cavity that can receive, for example, a pair of eyeglasses without scratching the eyeglasses due to the presence of the lining.

FIG. 5C illustrates an example eyeglasses securing device 500 that includes one or more attachment devices 540 to attach the device 500 to a reading material such as, for example, a book. According to various aspects, the attachment devices 540 may include an elastic band that may be used with, for example, a book. FIG. 5D illustrates an example device 500 that also includes an additional pocket 550 that can accommodate, for example, a pen or other object.

One variation in accordance with aspects of the present invention may include using the eyeglass case to hold sunglasses, so that an individual may attach a pair of sunglasses to reading material the individual plans to read outside (e.g., at the pool and/or at the beach), or for example may attach it to a sun visor in a car.

Another variation of the present invention may include securing an attachment component to an eyeglass case comprising a material other than fabric, such as plastic.

While aspects of the present invention have been described in connection with examples thereof, it will be understood by those skilled in the art that variations and modifications of the aspects of the present invention described above may be made without departing from the scope hereof. Other aspects will be apparent to those skilled in the art from a consideration of the specification or from a practice in accordance with aspects of the invention disclosed herein.

What is claimed is:

1. A device for attaching eyeglasses to reading materials, comprising:
an eyeglass case operable for holding eyeglasses; and
a securing component connected to the eyeglass case,
wherein the securing component is configured to temporarily secure the eyeglass case to an object.

2. The device of claim 1, wherein the eyeglass case comprises:
an inner fabric layer;
an outer fabric layer;
a padding attached to the outer fabric layer; and
a lining in an interior cavity of the eyeglass case formed by the inner fabric layer, the outer fabric layer and the padding joined together.

3. The device of claim 2, wherein a texture of the lining is configured to prevent damage to the eyeglasses.

4. The device of claim 1, further comprising a closure coupling the inner fabric layer and the outer fabric layer and configured to prevent the eyeglasses from falling out of the device.

5. The device of claim 4, wherein the closure is a closure of the eyeglass case.

6. The device of claim 4, wherein the closure comprises at least one selected from a group consisting of a snap, a Velcro® strip, a fastener, a button, and a zipper.

7. The device of claim 2, wherein a size of at least one selected from a group consisting of the inner and outer fabric layers is greater than a size of the padding.

8. The device of claim 2, wherein at least one selected from a group consisting of the inner and outer fabric layers comprises at least one selected from a group consisting of cotton, silk, fleece and wool.

9. The device of claim 2, wherein at least one selected from a group consisting of the inner and outer fabric layers has a generally square shape with a curve at one corner.

10. The device of claim 2, wherein the padding has a generally square shape with a curve at one corner.

11. The device of claim 2, wherein the padding comprises at least one selected from a group consisting of foam, cotton, fleece and rubber.

12. The device of claim 7, wherein the diameter of the padding in one direction is about one inch smaller than the diameter in one direction of the inner or outer fabric layers.

13. The device of claim 1, wherein the object is a piece of reading material.

14. The device of claim 1, wherein the attaching component comprises at least one selected from a group consisting of an elastic band, a rubber band, a neoprene band and a fabric band.

15. A method of assembling an eyeglass case comprising:
attaching a padding to an outer fabric component;
sewing the outer fabric component to an inner fabric component along one side of each of the outer fabric component and the inner fabric component such that the outer fabric component and the inner fabric component are thereby attached;
folding the sewably attached outer fabric component and inner fabric component along a fold line;
sewing aligned edges of the folded outer fabric component that are located between the fold line and the side sewably attaching the outer fabric and inner fabric; and
inserting the lining fabric component into a cavity formed by the fold line and the two sewn adjoining edges of the outer fabric component.

16. The method of claim 15, further comprising attaching a securing device to the eyeglass case.

17. The method of claim 15, wherein the padding is attached to the outer fabric component via at least one selected from a group consisting of sewing, gluing and ironing.
